(19) United States
(12) Patent Application Publication
(10) Pub. No.: US 2013/0308698 A1
(43) Pub. Date: Nov. 21, 2013

(54) RATE AND DISTORTION ESTIMATION METHODS AND APPARATUS FOR COARSE GRAIN SCALABILITY IN SCALABLE VIDEO CODING

(71) Applicant: INDUSTRIAL TECHNOLOGY RESEARCH INSTITUTE, Hsinchu (TW)

(72) Inventors: Wen-Hsiao Peng, Hsinchu County (TW); Chung-Hao Wu, Nantou County (TW)

(73) Assignee: Industrial Technology Research Institute, Hsinchu (TW)

(21) Appl. No.: 13/871,008

(22) Filed: Apr. 26, 2013

Related U.S. Application Data
(60) Provisional application No. 61/648,627, filed on May 18, 2012.

(30) Foreign Application Priority Data
Jan. 18, 2013 (TW) 102102049

(51) Int. Cl. H04N 7/26

(52) U.S. Cl. CPC H04N 19/00442
USPC 375/240.03

(57) ABSTRACT

Mode-dependent rate and distortion estimation methods for coarse grain scalability (CGS) in scalable video coding (SVC) are provided. The rate and distortion values of a base layer and an enhancement layer are estimated based on different combinations of a block partition size of the base layer block, a transform block size of the base layer transform, and a quantization parameter of the base layer quantization as well as a block partition size of the enhancement layer block, a transform block size of the enhancement layer transform, a quantization parameter of the enhancement layer, and a setting of the inter-prediction, and a mode pair for CGS in SVC may be selected accordingly based on the estimation of the rate and distortion values of the base layer and the enhancement layer. The disclosure also provides a mode-dependent rate and distortion estimation apparatus to realize the above method.

### CROSS-REFERENCE TO RELATED APPLICATION

This application claims the priority benefits of U.S. provisional application Ser. No. 61/648,627, filed on May 18, 2012 and Taiwan application serial no. 102102049, filed on Jan. 18, 2013. The entirety of each of the above-mentioned patent applications is hereby incorporated by reference herein and made a part of this specification.

### BACKGROUND

1. Technical Field

The disclosure relates to coarse grain scalability in scalable video coding technique.

2. Related Art

Under the development of digital multimedia in the present day, the high quality video streaming is widely available. The technique of video compression plays in a crucial role in receiving or transmitting image data while the storage capacity and the network bandwidth are limited. The H.264 is one of video standards currently used and is a video compression standard developed by the Video Coding Expert Group (VCEG) together with the Moving Pictures Experts Group (MPEG). The project partnership effort is known as the Joint Video Team (JVT). In addition to a higher compression ratio and video quality, the H.264/AVC video compression standard also includes the concepts of a video coding layer (VCL) and a network abstraction layer (NAL). Network information is provided through the network abstraction layer so that the H.264 compression standard may be employed in applications related to multimedia video streaming and mobile televisions. The fundamental principle of the video compression mainly invokes temporal and spatial proximity between images. When such similar video data is compressed, the portion undetectable by human vision, referred to as visual redundancy, is removed. After the visual redundancy is removed, the intent of video compression is achieved.

The minimum basic unit of the video data is a frame. A video coding mechanism with the H.264/AVC standard partitions each frame into a plurality of rectangular macroblocks (MB) and performs coding on the macroblocks. First, by employing a motion estimation technique of an intra-prediction and an inter-prediction, the similarity between the images are removed to obtain residuals in spatial domain and temporal domains, and then a block transform and a quantization are performed on the residuals to remove the visual redundancy. The block transform mainly applies the Discrete Cosine Transform (DCT) to decrease the visual redundancy. After the DCT is performed, predicted error data is quantized by a quantizer. At the same time, the quantization error data is reconstructed by the inverse quantization and the inverse DCT, and is then added to the previously predicted frame to form a reconstructed image, which is stored in a frame memory temporarily as a reference frame for motion estimation and motion compensation of the next frame. Next, the operations of deblock and entropy coding are performed on the quantized data. At end, the video coding layer outputs coded bitstreams, which are then packed in NAL-units in the network abstraction layer and transmitted to a remote terminal or stored in a storage media.

In terms of applications, although the H.264/AVC standard is highly efficient in compression, it may only provide a single rate for video coding. Along with the development of network and multimedia technology, videos are able to be watched online through wireless network by consumer products such as a personal computer (PC), a notebook computer, a tablet computer, a smart phone. Since the data processing ability of each device is different, such as available resolution or the network bandwidth, the video quality viewed by users are often limited by these factors. If videos are adaptively compressed according to each operating environment of each user, not only the efficiency of coding transmission may be decreased, but also the computation may be more complicated. To improve the situation described above, the H.264 scalable video coding (SVC) provides a coding architecture with a temporal scalability, a spatial scalability and a signal-to-noise ratio scalability (SNR scalability) between layers. A base layer, one or more enhancement layers and the inter-prediction are utilized to provide a multi-layer coding to satisfy network services with different properties. In other words, the scalable video coding may output bitstream of a high-quality video, and further includes one or more sub-bitstreams with lower video qualities, so that the user may select an appropriate bitstream to decode and watch according to user's environment.

The SNR scalability video coding may be further sub-divided into a coarse grain scalability (CGS), a median grain scalability (MGS) and a fine grain scalability (FGS). For the coarse grain scalability, the resolutions of the video data in the enhancement layer and base layer must be the same, wherein the video are coded in the H.264/AVC standard format in the base layer, and the video are coded in the H/264/AVC standard format as well as applying the inter-prediction in the enhancement layer so as to reduce residuals. Therefore, information from the base layer may be obtained without going through an interpolation process or a scaling process.

Although scalability video coding successfully improve the shortcoming of the traditional video coding with a single standard format, the efficiency decreases due to the computational complexity and multi-layer coding, which further affects the practical use of the scalability video coding. For instance, in view of two situations of the coarse grain scalability, i.e. the base layer and the enhancement layer, when a pair of macroblocks that are spatially the same but in different layers are compressed, various mode pairs are required to be performed, such as a block partition size of the macroblock, a transform block size, a quantization parameter, etc. When the step of mode decision is performed during the coding process, it is not possible to predict which one of the mode pairs is an optimal mode, wherein the optimal mode refers to a mode with the least trade-off between a rate value and a distortion value after a complete coding process. Therefore, the disclosure provides an effective algorithm to respectively calculate the rate and distortion values of the base layer and the enhancement layer for the coarse grain scalability coding, and the most suitable mode pair is searched therefrom so as to speed up the process of the video coding or to provide compressed images with a high quality in limited coding bit rate resource.

### SUMMARY

The disclosure provides a mode-dependent distortion estimation method for coarse grain scalability (CGS) in scalable video coding (SVC). The CGS in SVC performs a base layer coding and an enhancement layer coding on a macroblock. When the base layer coding is performed, the macroblock includes a base layer block, as well as a base layer transform, and a base layer quantization are performed so as to obtain a plurality of base layer transform coefficients of a plurality of base layer transform blocks. When the enhancement layer coding is performed, the macroblock includes an enhancement layer block, and an enhancement layer transform, an enhancement layer quantization as well as an inter-prediction are performed so as to obtain a plurality of enhancement layer transform coefficients of a plurality of enhancement layer of transform blocks. The distortion estimation method includes the following steps. First, a plurality of variances of the base layer transform coefficients are respectively calculated for each of the base layer transform blocks according to a block partition size of the base layer block, a transform block size of the base layer transform and a quantization parameter of the base layer quantization. Next, a distribution of the base layer transform coefficients is obtained according to the variances of the base layer transform coefficients. An expected value of the quantization error of the base layer transform coefficients are calculated for each of the base layer transform blocks according to the distribution of the base layer transform blocks and a quantization constant of the base layer quantization. Afterward, the expected value of the quantization error of the base layer transform coefficients of each of the base layer transform blocks are accumulated so as to generate a distortion value of the base layer. Furthermore, a plurality of variances of the enhancement layer transform coefficients are respectively calculated for each of the enhancement layer transform blocks according to the block partition size of the base layer block, the transform block size of the base layer transform, the quantization parameter of the base layer quantization, a block partition size of the enhancement layer block, a transform block size of the enhancement layer transform, a quantization parameter of the enhancement layer quantization and a setting of the inter-prediction. Moreover, a distribution of the enhancement layer transform coefficients is obtained according to the variances of the enhancement layer transform coefficients. An expected value of the quantization error of the enhancement layer transform coefficients are respectively calculated for each of the enhancement layer transform blocks according to the distribution of the enhancement layer transform coefficients and a quantization constant of the enhancement layer quantization. In addition, the expected value of the quantization error of the enhancement layer transform coefficients of each of the enhancement layer transform blocks are accumulated so as to generate a distortion value of the enhancement layer.

The disclosure provides a mode-dependent distortion estimation apparatus for CGS in SVC. The CGS in SVC performs a base layer coding and an enhancement layer coding on a macroblock. When the base layer coding is performed, the macroblock includes a base layer block, and a base layer transform as well as a base layer quantization are performed so as to obtain a plurality of base layer transform coefficients of a plurality of base layer transform blocks. When the enhancement layer coding is performed, the macroblock includes an enhancement layer block, and an enhancement layer transform, an enhancement layer quantization as well as an inter-prediction are performed so as to obtain a plurality of enhancement layer transform coefficients of a plurality of enhancement layer of transform blocks. The distortion estimation apparatus includes a base layer variance calculator, a base layer quantization error calculator, a base layer distortion estimator, an enhancement layer variance calculator, an enhancement quantization error calculator and an enhancement layer distortion estimator. The base layer variance calculator is configured to respectively calculate a plurality of variances of the base layer transform coefficients for each of the base layer transform blocks according to a block partition size of the base layer block, a transform block size of the base layer transform and a quantization parameter of the base layer quantization. The base layer quantization error calculator is configured to obtain a distribution of the base layer transform coefficients according to the variances of the base layer transform coefficients, and to respectively calculate an expected value of a quantization error of the base layer transform coefficients for each of the base layer transform blocks according to the distribution of the base layer transform blocks and a quantization parameter of the base layer quantization. The base layer distortion estimator is configured to accumulate the expected value of the quantization error of the base layer transform coefficients of each of the base layer transform blocks so as to generate a distortion value of the base layer. The enhancement layer variance calculator is configured to respectively calculate a plurality of variances of the enhancement layer transform coefficients for each of the enhancement layer transform blocks according to the block partition size of the base layer block, the transform block size of the base layer transform, the quantization parameter of the base layer quantization, a block partition size of the enhancement layer block, a transform block size of the enhancement layer transform, a quantization parameter of the enhancement layer quantization and a setting of the inter-prediction. The enhancement layer quantization error calculator is configured to obtain a distribution of the enhancement layer transform coefficients according to the variances of the enhancement layer transform coefficients, and to respectively calculate an expected value of the quantization error of the enhancement layer transform coefficients for each of the enhancement layer transform blocks according to the distribution of the enhancement layer transform coefficients and a quantization constant of the enhancement layer quantization. In addition, the enhancement layer distortion estimator is configured to accumulate the expected value of the quantization error of the enhancement layer transform coefficients of each of the enhancement layer transform blocks so as to generate a distortion value of the enhancement layer.

The disclosure provides a method of selecting a mode pair for CGS in SVC. The SGS in SVC performs a base layer coding and an enhancement layer coding on a macroblock. When the base layer coding is performed, the macroblock includes a base layer block, and a base layer transform as well as a base layer quantization are performed so as to obtain a plurality of base layer transform coefficients of a plurality of base layer transform blocks. When the enhancement layer coding is performed, the macroblock includes an enhancement layer block, and an enhancement layer transform, an enhancement layer quantization as well as an inter-prediction are performed so as to obtain a plurality of enhancement layer transform coefficients of a plurality of enhancement layer of transform blocks. The method includes the following steps. First, distortion values of the base layer and the enhancement layer of a plurality of different combinations are estimated according to the different combinations of a block partition size of the base layer block, a transform block size of the base layer transform, a quantization parameter of the base layer quantization, a block partition size of the enhancement layer block, a transform block size of the enhancement layer transform, a quantization parameter of the enhancement layer quantization and a setting of the inter-prediction. Next, the mode pair for the CGS in SVC is selected according to the distortion values of the base layer and the enhancement layer.

The disclosure provides a mode-dependent rate estimation method for CGS in SVC. The CGS in SVC performs a base layer coding and an enhancement layer coding to a macroblock. When the base layer coding is performed, the macroblock includes a base layer block, and a base layer transform as well as a base layer quantization are performed so as to obtain a plurality of base layer transform coefficients of a plurality of base layer transform blocks. When the enhancement layer coding is performed, the macroblock includes an enhancement layer block, and an enhancement layer transform, an enhancement layer quantization as well as an inter-prediction are performed so as to obtain a plurality of enhancement layer transform coefficients of a plurality of enhancement layer of transform blocks. The rate estimation method includes the following steps. First, a plurality of variances of the base layer transform coefficients for each of the base layer transform blocks are respectively calculated according to a block partition size of the base layer block, a transform block size of the base layer transform and a quantization parameter of the base layer quantization. Next, a distribution of the base layer transform coefficients is obtained according to the variances of the base layer transform coefficients. An entropy of the base layer transform coefficients are respectively calculated for each of the base layer transform blocks according to the distribution of the base layer transform blocks and a quantization constant of the base layer quantization. Afterward, the entropy the base layer transform coefficients of each of the base layer transform blocks is processed so as to generate a rate value of the base layer. Furthermore, a plurality of variances of the enhancement layer transform coefficients are respectively calculated for each of the enhancement layer transform blocks according to the block partition size of the base layer block, the transform block size of the base layer transform, the quantization parameter of the base layer quantization, a block partition size of the enhancement layer block, a transform block size of the enhancement layer transform, a quantization parameter of the enhancement layer quantization and a setting of the inter-prediction. Then, a distribution of the enhancement layer transform coefficients is obtained according to the variances of the enhancement layer transform coefficients. An entropy of the enhancement layer transform coefficients is respectively calculated for each of the enhancement layer transform blocks according to the distribution of the enhancement layer transform coefficients and a quantization constant of the enhancement layer quantization. Lastly, the entropy of the enhancement layer transform coefficients of each of the enhancement layer transform blocks is processed so as to generate a rate value of the enhancement layer.

The disclosure provides a mode-dependent rate estimation apparatus for CGS in SVC. The CGS in SVC performs a base layer coding and an enhancement layer coding on a macroblock. When the base layer coding is performed, the macroblock includes a base layer block, and a base layer transform as well as a base layer quantization are performed so as to obtain a plurality of base layer transform coefficients of a plurality of base layer transform blocks. When the enhancement layer coding is performed, the macroblock includes an enhancement layer block, and an enhancement layer transform, an enhancement layer quantization as well as an inter-prediction are performed so as to obtain a plurality of enhancement layer transform coefficients of a plurality of enhancement layer of transform blocks. The rate estimation apparatus includes a base layer variance calculator, a base layer entropy calculator, a base layer rate estimator, an enhancement layer variance calculator, an enhancement layer entropy calculator and an enhancement layer rate estimator. The base layer entropy calculator is configured to respectively calculate a plurality of variances of the base layer transform coefficients for each of the base layer transform blocks according to a block partition size of the base layer block, a transform block size of the base layer transform and a quantization parameter of the base layer quantization. The base layer entropy calculator is configured to obtain a distribution of the base layer transform coefficients according to the variances of the base layer transform coefficients, and to respectively calculate an entropy of the base layer transform coefficients for each of the base layer transform blocks according to the distribution of the base layer transform coefficients and a quantization constant of the base layer quantization. The base layer rate estimator is configured to process the entropy of the base layer transform coefficients of each of the base layer transform blocks so as to generate a rate value of the base layer. The enhancement layer variance calculator is configured to respectively calculate a plurality of variances of the enhancement layer transform coefficients for each of the enhancement layer transform blocks according to the block partition size of the base layer block, the transform block size of the base layer transform, the quantization parameter of the base layer quantization, a block partition size of the enhancement layer block, a transform block size of the enhancement layer transform, a quantization parameter of the enhancement layer quantization and a setting of the inter-prediction. The enhancement layer entropy calculator is configured to obtain a distribution of the enhancement layer transform coefficients according to the variances of the enhancement layer transform coefficients, and to respectively calculate an entropy of the enhancement layer transform coefficients for each of the enhancement layer transform blocks according to the distribution of the enhancement layer transform coefficients and a quantization constant of the enhancement layer quantization. In addition, the enhancement layer rate estimator is configured to process the entropy of the enhancement layer transform coefficients of each of the enhancement layer transform blocks so as to generate a rate value of the enhancement layer.

The disclosure provides a method of selecting a mode pair for CGS in SVC. The CGS in SVC performs a base layer coding and an enhancement layer coding on a macroblock. When the base layer coding is performed, the macroblock includes a base layer block, and a base layer transform as well as a base layer quantization are performed so as to obtain a plurality of base layer transform coefficients of a plurality of base layer transform blocks. When the enhancement layer coding is performed, the macroblock includes an enhancement layer block, and an enhancement layer transform, an enhancement layer quantization as well as an inter-prediction are performed so as to obtain a plurality of enhancement layer transform coefficients of a plurality of enhancement layer of transform blocks. The method includes the following steps. First, rate values of the base layer and the enhancement layer of a plurality of different combinations are estimated according to the different combinations of a block partition size of the base layer block, a transform block sizes of the base layer transform, a quantization parameter of the base layer quantization, a block partition size of the enhancement layer block, a transform block size of the enhancement layer transform, a quantization parameter of the enhancement layer quantization and a setting of the inter-prediction. Then, the mode pair for the CGS in SVC is selected according to the rate values of the base layer and the enhancement layer.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram illustrating a mode-dependent rate and distortion estimation apparatus for coarse grain scalability in scalable video coding according to an embodiment of the disclosure.

FIG. 2 is a flowchart illustrating a mode-dependent rate and distortion estimation method for coarse grain scalability in scalable video coding according to an embodiment of the disclosure.

### DETAILED DESCRIPTION OF DISCLOSED EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

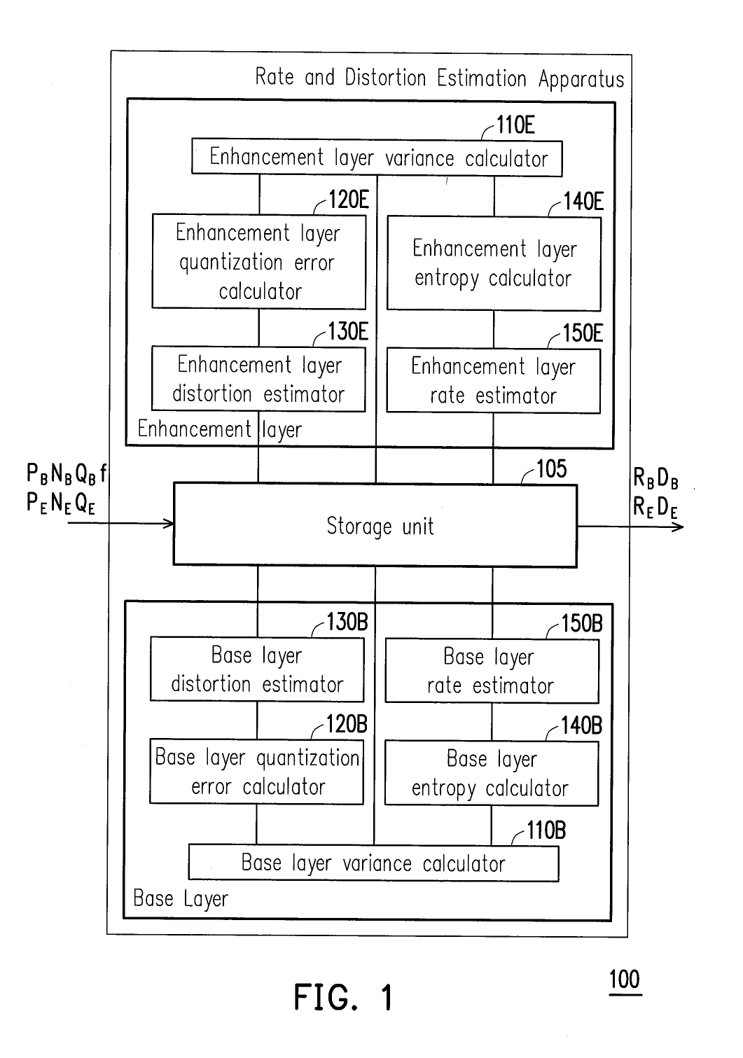

FIG. 1 is a block diagram illustrating a mode-dependent rate and distortion estimation apparatus for coarse grain scalability (CGS) in scalable video coding (SVC). FIG. 1 is illustrated for purposes of clarity and ease of explanation, though it is not intended to limit the disclosure. First, FIG. 1 introduces the components of the rate and distortion estimation apparatus and their coupling configuration, and detailed descriptions of these components will be disclosed along with the method later on.

With reference to FIG. 1, a rate-distortion estimation apparatus 100 includes a storage unit 105, a base layer variance calculator 110B, a base layer quantization error calculator 120B, a base layer distortion estimator 130B, a base layer entropy calculator 140B, a base layer rate estimator 150B, an enhancement layer variance calculator 110E, an enhancement layer quantization error calculator 120E, an enhancement layer distortion estimator 130E, an enhancement layer entropy calculator 140E and an enhancement layer rate estimator 150E. The storage unit 105 is coupled to the base layer variance calculator 110B and the enhancement layer variance calculator 110E. However, the storage unit 105 herein is not intended to limit the disclosure. In other embodiments, it can be replaced by other devices, such as a controller. In the base layer, the base layer quantization error calculator 120B is coupled to the base layer variance calculator 110B, and the base layer distortion estimator 130B is coupled to the base layer quantization error calculator 120B; the base layer entropy calculator 140B is coupled to the base layer variance calculator 110B, and the base layer rate estimator 150B is coupled to the base layer entropy calculator 140B; the base layer distortion estimator 130B and the base layer rate estimator 150B are respectively coupled to the storage unit 105. On the other hand, in the enhancement layer, the enhancement layer quantization error calculator 120E is coupled to the enhancement layer variance calculator 110E, and the enhancement layer distortion estimator 130E is coupled to the enhancement layer quantization error calculator 120E; the enhancement layer entropy calculator 140E is coupled to the enhancement layer variance calculator 110E, and the enhancement layer rate estimator 150E is coupled to the enhancement layer entropy calculator 140E; the enhancement layer distortion estimator 130E and the enhancement layer rate estimator 150E are respectively coupled to the storage unit 105. Although the rate and distortion estimation apparatus 100 includes aforementioned components, all or part of the components may be implemented by a single hardware apparatus or a plurality of hardware apparatuses. For instance, the rate and distortion estimation apparatus 100 may be implemented separately by a rate estimation apparatus and a distortion estimation apparatus.

In the present embodiment, when the CGS in SVC is performed on a macroblock, the operation may be categorized into a base layer coding and an enhancement layer coding. When the base layer coding is performed, the macroblock is defined as a base layer block, and a base layer transform as well as a base layer quantization are performed in the base layer so as to obtain a plurality of base layer transform coefficients of a plurality of base layer transform blocks. When the enhancement layer coding is performed, the macroblock is defined as an enhancement layer block, and an enhancement layer transform as well as an enhancement layer quantization are performed in the enhancement layer so as to obtain a plurality of enhancement transform coefficients of a plurality of enhancement layer transform blocks.

Two different coding methods are performed on the macroblock during the process of video data coding; that is, an inter-prediction coding method and an intra-prediction coding method. By utilizing the property of similarity of two adjacent frames in the video data, a motion estimation is performed on the macroblock in the second frame and the macroblock in the first frame so as to determine the coding method. If the macroblock found in the first frame is very similar to the macroblock of the second frame, the inter-prediction may be employed. If there are no macroblocks similar to each other between the first and second frames, the intra-prediction coding method may be employed. Furthermore, in the H.264 compression standard, there are seven types of macroblocks: 16×16, 16×8, 8×16, 8×8, 8×4, 4×8 and 4×4. Most algorithms commonly use 4×4 and 8×8 integer discrete cosine transforms (iDCT) for block transform. Since elements in the iDCT are all integers, a mismatch due to decimal places may not occur during decoding and encoding processes.

In the present embodiment, the inter-prediction is performed, and the distortion estimation of the base layer transform blocks and the enhancement layer transform blocks are performed by the 4×4 iDCT, though the disclosure is not limited thereto. In other embodiments, the inter-prediction and other transform methods may be performed. When the 4×4 iDCT are performed on residuals in the base layer, the base layer block generates 16 4×4 base layer transform blocks, and each of the base layer transform blocks includes 16 base layer transform coefficients; that is, the DCT transform coefficients.

First, the theory of the base layer coding is illustrated herein. In general, the base layer transform coefficients of each of the base layer transform blocks follow a zero-mean Laplace distribution with a different variance. In other words, the shape of each of the distributions is controlled respectively by the corresponding variance. When the base layer transform coefficients pass through a quantizer, a generated quantization error of each of the base layer transform coefficients may be represented by Equation (1):

$${D}_{B} ( i ) = {σ}_{B}^{2} ( i ) - ( 2 α + \sqrt{2} {σ}_{B} ( i ) ) \times \frac{exp ( \frac{- q ( {QP}_{B} ) - 2 α}{\sqrt{2} {σ}_{B} ( i )} ) \times q ( {QP}_{B} )}{1 - exp ( \frac{- \sqrt{2} q ( {QP}_{B} )}{{σ}_{B} ( i )} )} , \qquad Equation ( 1 )$$

wherein i is a base layer transform coefficient, σ_{B}(i) is a standard deviation of the base layer transform coefficient i, QP_{B} is a quantization parameter of the base layer quantization, q is a quantization function, q(QP_{B}) represents a quantization stepsize used by the quantizer, and α is a quantization constant of the base layer quantization. On the other hand, a generated entropy of the base layer transform coefficients may be represented by Equation (2):

$${H}_{B} ( i ) = - ( 1 - {p}_{B}^{′} \sqrt{{p}_{B}} ) {log}_{2} ( 1 - {p}_{B}^{′} \sqrt{{p}_{B}} ) - {p}_{B}^{′} \sqrt{{p}_{B}} {log}_{2} ( \frac{{p}_{B}^{′} ( 1 - {p}_{B} )}{2 \sqrt{{p}_{B}}} ) - \frac{{p}_{B}^{′} \sqrt{{p}_{B}} {log}_{2} {p}_{B}}{1 - {p}_{B}} , \qquad Equation ( 2 )$$

wherein P_{B}=exp(−\sqrt{2}q (QP_{B})/σ_{B}(i)) and p′B=exp(−\sqrt{2}α/σ_{B}(i)). A distortion model D_{B} of the base layer first calculates an expected value of the quantization error for the base layer transform coefficients of each of the base layer transform blocks and then accumulates the expected values. A rate model R_{B} of the base layer may be represented by Equation (3):

$$ln {R}_{B} = a [ \frac{\sqrt{2}}{{\overline{σ}}_{B}} ln {\overline{H}}_{B} - ( 1 + \frac{\sqrt{2}}{{\overline{σ}}_{B}} ) ln q ( {QP}_{B} ) - \frac{\sqrt{2}}{{\overline{σ}}_{B}} ] + b , \qquad Equation ( 3 )$$

wherein σ̅_{B} is a root mean square (rms) of the standard deviation σ_{B}(i) of all the base layer transform coefficients in the base layer transform block, H̅_{B} is an arithmetic mean of the entropy of all the base layer transform coefficients in the base layer transform block H_{B} (i), a and b are video-related parameters, which may be obtained from training data.

By leveraging the quantization and entropy coding mechanisms during compression simulated by a forward channel model in the information theory as well as a motion compensation mechanism, the variance of the base layer transform coefficients may be represented by Equation (4):

σ_{B}²(i)=2r_{f}^{B}(0;i)−2r_{f}^{B}(1;i) Equation (4),

wherein r_{f}^{B}(0; i) is an i-th variance of a predicted block in the base layer in a transform domain, and r_{f}^{B}(1; i) is an i-th covariance between the predicted block and a corresponding motion compensation predicted block in the transform domain. It should be noted that “the predicted block” refers to as the base layer transform block, and “the corresponding motion compensation predicted block” refers to as one of the adjacent blocks having a same spatial position adjacent to the base layer transform block within a reference frame.

By viewing the base layer transform block as the basic unit for calculation, the variance and the covariance between the predicted block and the corresponding motion compensation predicted block in the spatial domain are first calculated, and then the variance r_{f}^{B}(0; i) and the covariance r_{f}^{B}(1; i) in the transform domain are calculated. Since a motion vector used by the predicted block may be equivalent to the motion magnitude at the center point of the predicted block, different motion partition structures (i.e., different predicted block sizes) used to implement the base layer transform blocks of the motion compensation prediction result in different predictions, and therefore produce variances and the covariances in different spatial domains.

If a brightness statistical model and a motion statistical model in the spatial domain are applied to simulate the characteristics of the video source, such as the following three equations:

$$E \{ {I}_{k} ( {s}_{1} ) {I}_{k} ( {s}_{2} ) \} = {σ}_{I}^{2} ( 1 - \frac{{‖ {s}_{1} - {s}_{2} ‖}_{2}^{2}}{K} )$$

$$E \{ {v}_{x} ( {s}_{1} ) {v}_{x} ( {s}_{2} ) \} = E \{ {v}_{y} ( {s}_{1} ) {v}_{y} ( {s}_{2} ) \} = {σ}_{m}^{2} {ρ}_{m}^{{‖ {s}_{1} - {s}_{2} ‖}_{1}}$$

$${I}_{k} ( s ) = {I}_{k - 1} ( s + v ( s ) ) ,$$

wherein Iₖ(s) and v (s)=(υₓ(s) υ_{y}(s)) respectively represent the brightness and the motion magnitude of a pixel s in a k-th frame, Iₖ₋₁ of the (k−1)-th frame represents a reference frame, {σ_{I}², K} is the variance and the coefficient parameter related to the brightness, and {σₘ²,ρₘ} is the variance and the coefficient parameter related to the motion magnitude. Since the predicted block size of 16×16 is used for prediction followed by a 4×4 transform by the base layer block, the variance and the covariance in the spatial domain with the brightness block size of 4×4 (with the same position as the 4×4 transform block) in the predicted block as a basic unit may be represented by Equation (5) and Equation (6) respectively:

$$\begin{matrix}{[ E \{ ( {f}_{k}^{B} ) {( {f}_{k}^{B} )}^{t} \} ]}_{ij} = {σ}_{I}^{2} [ 1 - \frac{{‖ {s}_{i} - {s}_{j} ‖}_{2}^{2}}{K} - \frac{4 {σ}_{m}^{2} ( 1 - {ρ}_{m}^{{‖ {s}_{i} - {s}_{j} ‖}_{1}} )}{K} ] & Equation ( 5 ) \\ {[ E \{ ( {f}_{k - 1}^{B} ) {( {f}_{k}^{B} )}^{t} \} ]}_{ij} = {σ}_{I}^{2} [ 1 - \frac{{‖ {s}_{i} - {s}_{j} ‖}_{2}^{2}}{K} - \frac{4 {σ}_{m}^{2} ( 1 - {ρ}_{m}^{{‖ {s}_{c} - {s}_{j} ‖}_{1}} )}{K} ] & Equation ( 6 )\end{matrix}$$

wherein fₖ^{B} is a 16-dimensional vector generated through a column-major vectorization on the 4×4 brightness block in the predicted block, fₖ₋₁^{B} is a 16-dimensional vector generated through the column-major vectorization on the 4×4 brightness block in the corresponding motion compensation predicted block, t is a transpose operation of a vector, i is an i-th element of a former vector between two multiplied vectors, sᵢ is a coordinate of the i-th element in the block belonging to the i-th element (i.e., the predicted block or the motion compensation predicted block), j is a j-th element of a latter vector between two multiplied vectors, sⱼ is a coordinate of the j-th element in the predicted block, and s_{c} is a coordinate of the center of the predicted block with a block size of 16×16. The variance r_{f}^{B}(0; i) and the covariance r_{f}^{B}(1; i) in the transform domain can be represented as Equation (7):

r_{f}^{B}(j;i)=[(T_{B} [symbol] T_{B})E{(fₖ₋ⱼ^{B})(fₖ^{B})^{t}}(T_{B} [symbol] T_{B})^{t}]ᵢᵢ Equation (7),

wherein T_{B} is a transform matrix of the DCT adapted by the base layer block, and \textcircled{×} is a Kronecker product operator.

Based on the above description, the rate and distortion values of the base layer may be calculated when the variance of the brightness of the base layer block σ_{I}², the coefficient parameter related to the brightness K, the variance of the motion magnitude σₘ², the coefficient parameter related to the motion magnitude ρₘ and a mode pair to be estimated for coding are given.

Next, the theory of the enhancement layer coding is illustrated. In the present embodiment, the enhancement layer employs an inter-layer residual prediction. Therefore, the rate and distortion models of the enhancement layer are different from that of the base layer. When the inter-layer residual prediction is performed on the enhancement transform coefficients of each of the enhancement layer transform blocks, the enhancement transform coefficients may also follow a zero-mean Laplace distribution with different variances. When the enhancement layer transform coefficients pass through the quantizer, a generated quantization error of each of the enhancement layer transform coefficients may be represented by Equation (8):

$${D}_{E} ( i ) = {σ}_{E}^{2} ( i ) - ( 2 α + \sqrt{2} {σ}_{E} ( i ) ) \times \frac{exp ( \frac{- q ( {QP}_{E} ) - 2 α}{\sqrt{2} {σ}_{E} ( i )} ) \times q ( {QP}_{E} )}{1 - exp ( \frac{- \sqrt{2} q ( {QP}_{E} )}{{σ}_{E} ( i )} )} , \qquad Equation ( 8 )$$

wherein i is an enhancement layer transform coefficient, σ_{E}(i) is a standard deviation of the enhancement layer transform coefficients, QP_{E} is a quantization parameter of the enhancement layer quantization, q is a quantization function, q(QP_{E}) represents a quantization stepsize used by the quantizer, and α is a quantization constant. On the other hand, a generated entropy of the enhancement transform coefficients may be represented by Equation (9):

$${H}_{E} ( i ) = - ( 1 - {p}_{E}^{′} \sqrt{{p}_{E}} ) {log}_{2} ( 1 - {p}_{E}^{′} \sqrt{{p}_{E}} ) - {p}_{E}^{′} \sqrt{{p}_{E}} {log}_{2} ( \frac{{p}_{E}^{′} ( 1 - {p}_{E} )}{2 \sqrt{{p}_{E}}} ) - \frac{{p}_{E}^{′} \sqrt{{p}_{E}} {log}_{2} {p}_{E}}{1 - {p}_{E}} , \qquad Equation ( 9 )$$

wherein and p_{E}=exp (−\sqrt{2}q(QP_{E})/σ_{E}(i)) and p′_{E}=exp (−\sqrt{2}α/σ_{E}(i)). A distortion model D_{E} of the enhancement layer first calculates an expected value of the quantization error of the enhancement layer transform coefficients for each of the enhancement layer transform blocks, and then accumulates the expected values. A rate model R_{E} of the enhancement layer may be represented by Equation (10):

$$ln {R}_{E} = c [ \frac{\sqrt{2}}{{\overline{σ}}_{E}} ln {\overline{H}}_{E} - ( 1 + \frac{\sqrt{2}}{{\overline{σ}}_{E}} ) ln q ( {QP}_{E} ) - \frac{\sqrt{2}}{{\overline{σ}}_{E}} ] + d , \qquad Equation ( 10 )$$

wherein σ̅_{E} is a root mean square of the standard deviation σ_{E} (i) of all of the enhancement layer transform coefficients in the enhancement layer transform block, H̅_{E} is an arithmetic mean of the entropy of all of the enhancement layer transform coefficients of the enhancement layer transform block H_{E} (i), c and d are video-related parameters, which may be obtained from the training data.

Similarly, by leveraging the quantization and entropy coding mechanisms during compression simulated by a forward channel model in the information theory as well as a motion compensation mechanism and the inter-layer residual prediction, the variance of the enhancement layer coefficients may be represented by Equation (11):

$${( {σ}_{E}^{2} ( i ) )}^{2} = [ \begin{matrix}( 2 - 2 {β}_{i}^{B} ) ( {r}_{f}^{E} ( 0 ; i ) - {r}_{f}^{E} ( 1 ; i ) ) + \\ {D}_{E} ( i ) + {β}_{i}^{B} ( 2 {r}_{f}^{B} ( 1 ; i ) + {σ}_{B}^{2} ( i ) )\end{matrix} ] {σ}_{E}^{2} ( i ) - [ ( 2 - 2 {β}_{i}^{B} ) {r}_{f}^{E} ( 0 ; i ) - 2 {r}_{f}^{E} ( 1 ; i ) + 2 {β}_{i}^{B} {r}_{f}^{B} ( 1 ; i ) ] {D}_{E} ( i ) , \qquad Equation ( 11 )$$

wherein r_{f}^{E} (0; i) is an i-th variance of a predicted block in the enhancement layer in the transform domain, r_{f}^{E} (1; i) is an i-th covariance between the predicted block and a corresponding motion compensation predicted block (the adjacent block) in the transform domain, and βᵢ^{B}=1−D_{B}(i)/σ_{B}²(i), σ_{B}²(i) and r_{f}^{E} (1; i) are calculated by the coding method applied in the base layer.

For the variance and the covariance in the transform domain, only the variance of the brightness σ_{I}², the brightness related coefficients parameter K, the motion variance parameter σₘ², the motion related coefficient ρₘ and the mode pair to be estimated for coding are changed to the setting of the enhancement layer, the calculation is similar to Equations (5), (6) and (7), which can be respectively represented as Equation (12), Equation (13) and Equation (14):

$$\begin{matrix}{[ E \{ ( {f}_{k}^{E} ) {( {f}_{k}^{E} )}^{t} \} ]}_{ij} = {σ}_{I}^{2} [ 1 - \frac{{‖ {s}_{i} - {s}_{j} ‖}_{2}^{2}}{K} - \frac{4 {σ}_{m}^{2} ( 1 - {ρ}_{m}^{{‖ {s}_{i} - {s}_{j} ‖}_{1}} )}{K} ] , & Equation ( 12 ) \\ {[ E \{ ( {f}_{k - 1}^{E} ) {( {f}_{k}^{E} )}^{t} \} ]}_{ij} = {σ}_{I}^{2} [ 1 - \frac{{‖ {s}_{i} - {s}_{j} ‖}_{2}^{2}}{K} - \frac{4 {σ}_{m}^{2} ( 1 - {ρ}^{{‖ {s}_{c} - {s}_{j} ‖}_{1}} )}{K} ] , & Equation ( 13 ) \\ {r}_{f}^{E} ( j ; i ) = {[ ( {T}_{E} ⊗ {T}_{E} ) E \{ ( {f}_{k - j}^{E} ) {( {f}_{k}^{E} )}^{t} \} {( {T}_{E} ⊗ {T}_{E} )}^{t} ]}_{ii} , & Equation ( 14 )\end{matrix}$$

wherein fₖ^{E} is 16-dimensional vector generated through a column-major vectorization on the 4×4 brightness block in the predicted block, fₖ₋₁^{E} is a 16-dimensional vector generated through the column-major vectorization on the 4×4 brightness block in the corresponding motion compensation predicted block, t is a vector transpose operation, i is an i-th element of a former vector between two multiplied vectors, sᵢ is a coordinate of the i-th element in the block belonging to the i-th element (i.e., the predicted block or the motion compensation predicted block); j is a vector of a j-th element of a latter vector between the two multiplied vectors, sⱼ is a coordinate of the j-th element in the predicted block, s_{c} is a coordinate of the center of the predicted block with a block size of 16×16, and T_{E} is a DCT transform matrix adopted by the enhancement layer block.

Based on the above description, the rate and distortion values of the enhancement layer may be calculated when the variance of the brightness of the enhancement layer block σ_{I}², the coefficient parameter related to the brightness K, the variance parameter of the motion magnitude σₘ², the coefficient parameter related to the motion magnitude ρₘ and the mode pair for coding to be estimated are given.

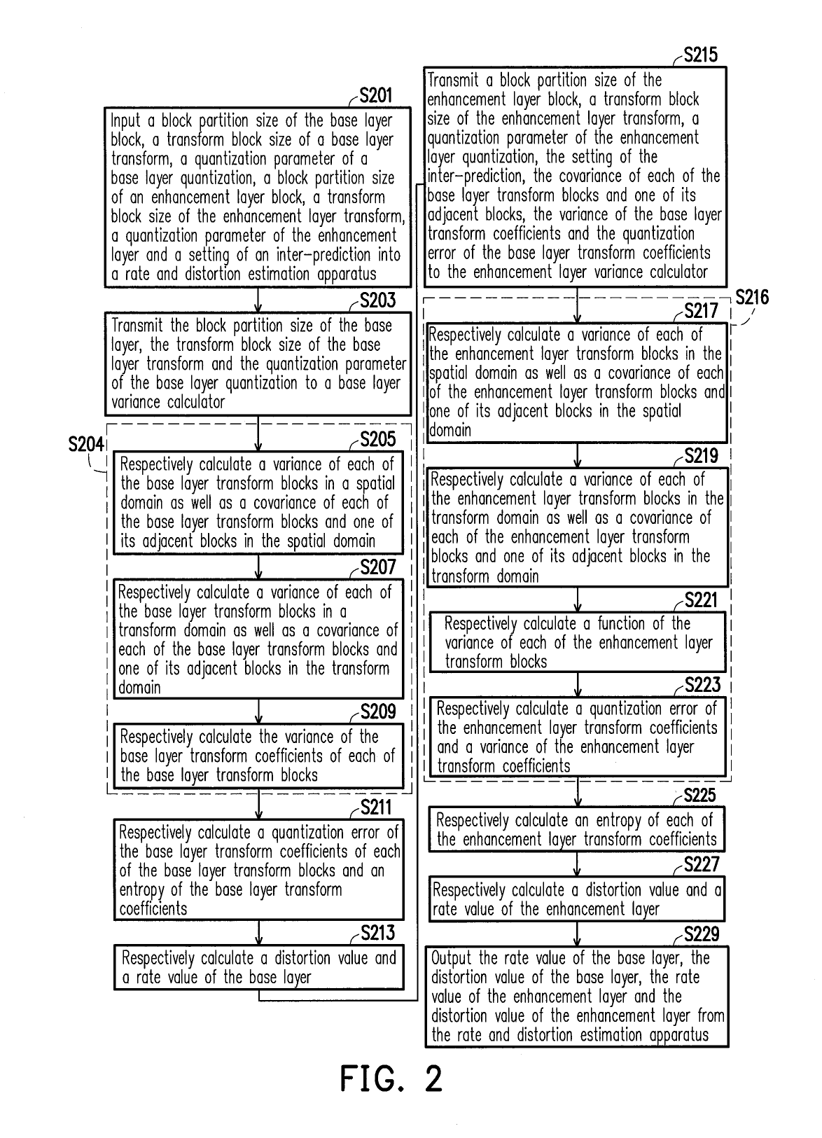

FIG. 2 is a flowchart illustrating a mode-dependent rate and distortion estimation method for coarse grain scalability in scalable video coding according to an embodiment of the disclosure. With reference to FIG. 1 and FIG. 2, the variance of the brightness of the base layer and the enhancement layer σ_{I}², the coefficient parameter related to the brightness K, the variance of the motion magnitude σₘ² and the coefficient parameter related to motion magnitude ρₘ are pre-configured. First, the coding of the base layer is performed. A block partition size of the base layer block P_{B}, a transform block size of the base layer transform N_{B}, a quantization parameter of the base layer quantization Q_{B}, a block partition size of the enhancement layer block P_{E}, a transform block size of the enhancement layer transform N_{E}, a quantization parameter of the enhancement layer Q_{E} and a setting of inter-prediction f are inputted into the storage unit 105 of the rate and distortion estimation apparatus 100 (step S201).

Next, the block partition size of the base layer P_{B}, the transform block size of the base layer transform N_{B} and the quantization parameter of the base layer quantization Q_{B}, are transmitted from the storage unit 105 to the base layer variance calculator 110B (step S203).

The base layer variance calculator 110B respectively calculates the variance of the base layer transform coefficients σ_{B}²(i) in each of the base layer transform blocks (step S204), where the step S204 can be further sub-divided into a step S205, a step S207 and a step S209, which are illustrated as follows.

The base layer variance calculator 110B respectively calculates the variance of each of the base layer transform block in the spatial domain as well as the covariance between each of the base layer transform blocks and one of its adjacent blocks in the spatial domain (step S205) in accordance with Equation (5) and Equation (6), which are shown as follows:

$$\begin{matrix}{[ E \{ ( {f}_{k}^{B} ) {( {f}_{k}^{B} )}^{t} \} ]}_{ij} = {σ}_{I}^{2} [ 1 - \frac{{‖ {s}_{i} - {s}_{j} ‖}_{2}^{2}}{K} - \frac{4 {σ}_{m}^{2} ( 1 - {ρ}_{m}^{{‖ {s}_{i} - {s}_{j} ‖}_{1}} )}{K} ] & \\ {[ E \{ ( {f}_{k - 1}^{B} ) {( {f}_{k}^{B} )}^{t} \} ]}_{ij} = {σ}_{I}^{2} [ 1 - \frac{{‖ {s}_{i} - {s}_{j} ‖}_{2}^{2}}{K} - \frac{4 {σ}_{m}^{2} ( 1 - {ρ}_{m}^{{‖ {s}_{c} - {s}_{j} ‖}_{1}} )}{K} ] & \end{matrix}$$

In addition, according to the outcomes of Equation (5) and Equation (6) along with Equation (7), that is,

r_{f}^{B}(j;i)=[(T_{B} [symbol] T_{B})E{(fₖ₋ⱼ^{B})(fₖ^{B})^{t}}(T_{B} [symbol] T_{B})^{t}]ᵢᵢ,

the base layer variance calculator 110B respectively calculates the variance of each of the base layer transform blocks in the transform domain r_{f}^{B}(0; i) as well as the covariance between each of the base layer transform blocks and one of its adjacent blocks in the transform domain r_{f}^{B}(1; i) (step S207).

Next, the variance of each of the base layer transform blocks r_{f}^{B}(0; i) as well as the covariance between each of the base layer transform blocks and one of its adjacent blocks in the transform domain r_{f}^{B}(1; i) are substituted into Equation (4), i.e.,

σ_{B}²(i)=2r_{f}^{B}(0;i)−2r_{f}^{B}(1;i),

so as to obtain the variance of the base layer transform coefficients as σ_{B}²(i). The outcome of above operation is transmitted to the base layer quantization error calculator 120B, the base layer entropy calculator 140B and the storage unit 105. Furthermore, the covariance between each of the base layer transform blocks and one of its adjacent blocks σ_{B}²(i) are also transmitted to the storage unit 105 (step S209).

The base layer quantization error calculator 120B and the base layer entropy calculator 140B obtain a distribution of the base layer transform coefficients according to the variance of the base layer transform coefficients σ_{B}²(i). Furthermore, an expected value of the base layer transform coefficients quantization error and an entropy of the base layer transform coefficients of each of the base layer transform blocks in the base layer block are calculated according to the distribution of the base layer transform coefficients and a quantization constant of the base layer quantization. In other words, they are calculated in accordance with Equation (1) and Equation (2), that is,

$${D}_{B} ( i ) = {σ}_{B}^{i} ( i ) - ( 2 α + \sqrt{2} {σ}_{B} ( i ) ) \times \frac{exp ( \frac{- q ( {QP}_{B} ) - 2 α}{\sqrt{2} {σ}_{B} ( i )} ) \times q ( {QP}_{B} )}{1 - exp ( \frac{- \sqrt{2} q ( {QP}_{B} )}{{σ}_{B} ( i )} )}$$

$${H}_{B} ( i ) = - ( 1 - {p}_{B}^{′} \sqrt{{p}_{B}} ) {log}_{2} ( 1 - {p}_{B}^{′} \sqrt{{p}_{B}} ) - {p}_{B}^{′} \sqrt{{p}_{B}} {log}_{2} ( \frac{{p}_{B}^{′} ( 1 - {p}_{B} )}{2 \sqrt{{p}_{B}}} ) - \frac{{p}_{B}^{′} \sqrt{{p}_{B}} {log}_{2} {p}_{B}}{1 - {p}_{B}} .$$

In addition, the outcomes are transmitted to the base layer distortion estimator 130B and the base layer rate estimator 150B. It should be noted that the expected value of the quantization error of the base layer transform coefficients are also transmitted to the storage unit 105 (step S211).

The base layer distortion estimator 130B accumulates the expected value of the quantization error of each of the base layer transform coefficients in the base layer transform block to obtain the distortion of the base layer D_{B}. The base layer rate estimator 150B substitutes the entropy of the base layer transform coefficients of each of the base layer transform blocks into Equation (3), that is,

$$ln {R}_{B} = a [ \frac{\sqrt{2}}{{\overline{σ}}_{B}} ln {\overline{H}}_{B} - ( 1 + \frac{\sqrt{2}}{{\overline{σ}}_{B}} ) ln q ( {QP}_{B} ) - \frac{\sqrt{2}}{{\overline{σ}}_{B}} ] + b ,$$

to obtain the rate of the base layer R_{B}. Thereafter, the distortion D_{B} and the rate R_{B} of the base layer are respectively transmitted to the storage unit 105 (step S213). In other words, in addition to the block partition size of the base layer block P_{B}, the transform block size of the base layer transform N_{B}, the quantization parameter of the base layer quantization Q_{B}, the block partition size of the enhancement layer block P_{E}, the transform block size of the enhancement layer transform N_{E}, the quantization parameter of the enhancement layer quantization Q_{E} and the setting of the inter-prediction f, the storage unit 105 also stores the distortion value of the base layer D_{B}, the rate value of the base layer R_{B}, the covariance r_{f}^{B}(1; i) between each of the base layer transform blocks and one of its adjacent blocks, the variance of the base layer transform coefficients σ_{B}²(i) and the quantization error of the base layer transform coefficients D_{B} (i) calculated in each of the base layer transform blocks in the base layer block.

Next, in the enhancement layer coding, the block partition size of the enhancement layer block P_{E}, the transform block size of the enhancement layer transform N_{E}, the quantization parameter of the enhancement layer quantization Q_{E}, the setting of the inter-prediction f, the covariance r_{f}^{B}(1; i) between each of the base layer transform blocks and one of its adjacent blocks, the variance of the base layer transform coefficients σ_{B}²(i) and the quantization error of the base layer transform coefficients D_{B}(i) are transmitted to the enhancement layer variance calculator 110E (step S215).

Next, the enhancement layer variance calculator 110E respectively calculates the variance of the enhancement layer transform coefficients σ_{E}²(i) and the quantization error of the enhancement transform coefficients D_{E}(i) in each of the enhancement layer transform blocks (step S216), where the step S216 can be further sub-divided into steps S217, S219, S221 and S223, which are further described as follows.

The enhancement layer variance calculator 110E respectively calculates the variance of each of the enhancement layer transform blocks in the spatial domain as well as the covariance between each of the enhancement layer transform blocks and one of its adjacent blocks in the spatial domain (step S217) according to Equation (12) and Equation (13), that is

$$\begin{matrix}{[ E \{ ( {f}_{k}^{E} ) {( {f}_{k}^{E} )}^{t} \} ]}_{ij} = {σ}_{I}^{2} [ 1 - \frac{{‖ {s}_{i} - {s}_{j} ‖}_{2}^{2}}{K} - \frac{4 {σ}_{m}^{2} ( 1 - {ρ}_{m}^{{‖ {s}_{i} - {s}_{j} ‖}_{1}} )}{K} ] & \\ {[ E \{ ( {f}_{k - 1}^{E} ) {( {f}_{k}^{E} )}^{t} \} ]}_{ij} = {σ}_{I}^{2} [ 1 - \frac{{‖ {s}_{i} - {s}_{j} ‖}_{2}^{2}}{K} - \frac{4 {σ}_{m}^{2} ( 1 - {ρ}_{m}^{{‖ {s}_{c} - {s}_{j} ‖}_{1}} )}{K} ] . & \end{matrix}$$

Furthermore, according to the outcomes of the equations (12) and (13) along with Equation (14), that is,

r_{f}^{E}(j;i)=[(T_{E} [symbol] T_{E})E{(fₖ₋ⱼ^{E})(fₖ^{E})^{t}}(T_{E} [symbol] T_{E})^{t}]ᵢᵢ,

the enhancement layer variance calculator 110E calculates the variance of the enhancement layer transform blocks in transform domain r_{f}^{E}(0; i) as well as the covariance r_{f}^{E}(1; i) between each of the enhancement layer transform blocks and one of its adjacent blocks (step S219).

Next, the variance of each of the enhancement layer transform blocks in the transform domain r_{f}^{E}(0; i), the covariance r_{f}^{E}(1; i) between each of the enhancement layer transform blocks and one of its adjacent blocks in the transform domain, the covariance r_{f}^{B}(1; i) between each of the base layer transform blocks and one of its adjacent blocks in the transform domain, the variance σ_{B}²(i) of the base layer transform coefficients and the quantization error of the base layer transform coefficients calculated respectively from each of the base layer transform blocks in the base layer block D_{B}(i) are substituted into Equation (11), i.e.,

$${( {σ}_{E}^{2} ( i ) )}^{2} = [ \begin{matrix}( 2 - 2 {β}_{i}^{B} ) ( {r}_{f}^{E} ( 0 ; i ) - {r}_{f}^{E} ( 1 ; i ) ) + \\ {D}_{E} ( i ) + {β}_{i}^{B} ( 2 {r}_{f}^{B} ( 1 ; i ) + {σ}_{B}^{2} ( i ) )\end{matrix} ] {σ}_{E}^{2} ( i ) - [ ( 2 - 2 {β}_{i}^{B} ) {r}_{f}^{E} ( 0 ; i ) - 2 {r}_{f}^{E} ( 1 ; i ) + 2 {β}_{i}^{B} {r}_{f}^{B} ( 1 ; i ) ] {D}_{E} ( i ) .$$

Furthermore, Equation (11) substituted with the aforementioned parameters is transmitted to the enhancement layer quantization error calculator 120E, wherein βᵢ^{B}=1−D_{B}(i)/σ_{B}²(i) (step S221).

Afterward, the enhancement layer quantization calculator 120E obtains the quantization error D_{E} (i) and the variance of the enhancement layer transform coefficients σ_{E}²(i) by solving the simultaneous equations of Equation (8) and Equation (11) substituted with the aforementioned parameters, i.e.

$${D}_{E} ( i ) = {σ}_{E}^{2} ( i ) - ( 2 α + \sqrt{2} {σ}_{E} ( i ) ) \times \frac{exp ( \frac{- q ( {QP}_{E} ) - 2 α}{\sqrt{2} {σ}_{E} ( i )} ) \times q ( {QP}_{E} )}{1 - exp ( \frac{- \sqrt{2} q ( {QP}_{E} )}{{σ}_{E} ( i )} )} ,$$

and the outcome is transmitted to the enhancement layer distortion estimator 130E and the enhancement layer entropy calculator 140E (step S223). The enhancement layer quantization error calculator 120E in the present embodiment may transmit the variance of the enhancement layer transform coefficients σ_{E}²(i) to the enhancement entropy calculator 140E through the enhancement layer variance calculator 110E, though the present invention is not limited thereto. In other embodiment, the variance of the enhancement transform coefficients σ_{E}²(i) may be transmitted via a direct connection between the enhancement layer variance calculator 110E and the enhancement layer entropy calculator 140E.

Next, the enhancement layer entropy calculator 140E can substitute the variance of the enhancement layer transform coefficients σ_{E}²(i) into equation (9), i.e.,

$${H}_{E} ( i ) = - ( 1 - {p}_{E}^{′} \sqrt{{p}_{E}} ) {log}_{2} ( 1 - {p}_{E}^{′} \sqrt{{p}_{E}} ) - {p}_{E}^{′} \sqrt{{p}_{E}} {log}_{2} ( \frac{{p}_{E}^{′} ( 1 - {p}_{E} )}{2 \sqrt{{p}_{E}}} ) - \frac{{p}_{E}^{′} \sqrt{{p}_{E}} {log}_{2} {p}_{E}}{1 - {p}_{E}} ,$$

so as to obtain the entropy of the enhancement layer coefficients, and the outcome is transmitted to the enhancement layer rate estimator 150E (step S225).

The enhancement layer distortion calculator 130E accumulates the expected value of the quantization error of the enhancement layer transform coefficients of each of the enhancement layer transform blocks so as to obtain the distortion value of the enhancement layer D_{E}. Furthermore, the enhancement layer rate estimator 150E substitutes the entropy of the enhancement layer transform coefficients of each of the enhancement layer transform blocks into Equation (10), i.e.,

$$ln {R}_{E} = c [ \frac{\sqrt{2}}{{\overline{σ}}_{E}} ln {\overline{H}}_{E} - ( 1 + \frac{\sqrt{2}}{{\overline{σ}}_{E}} ) ln q ( {QP}_{E} ) - \frac{\sqrt{2}}{{\overline{σ}}_{E}} ] + d ,$$

so as to obtain the rate value of the enhancement layer R_{E}. Afterward, the distortion value D_{E} and rate value R_{E} of the enhancement layer are respectively transmitted to the storage unit 105 (step S227).

Next, the storage unit 105 outputs the rate value of the base layer R_{B}, the distortion value of the base layer D_{B}, the rate value of the enhancement layer R_{E} and the distortion value of the enhancement layer D_{E} from the rate and distortion estimation apparatus 100 (step S229). It may be determined whether the block partition size P_{B} of the base layer, the transform block size of the base layer transform N_{B}, the quantization parameter of the base layer quantization Q_{B}, the block partition size of the enhancement layer block P_{E}, the transform block size of the enhancement layer N_{E}, the quantization parameter of the enhancement layer Q_{E} and the setting of the inter-prediction f are a suitable mode pair according to the outputted rate value of the base layer R_{B}, the outputted distortion value of the base layer D_{B}, the outputted rate value of the enhancement layer R_{E} and the outputted distortion value of the enhancement layer D_{E}. The video data coded in the base layer block and the enhancement layer block may be based on the mode pair. It should be noted that the modes may also be paired selectively. For example, in one embodiment, the mode pair of the block partition size of the base layer P_{B}, the transform block size of the base layer N_{B}, the quantization parameter of the base layer quantization Q_{B} may be selected according to the distortion value of the base layer D_{B}, so as to perform the base layer coding.

In summary, mode-dependent rate and distortion estimation methods and apparatuses for coarse grain scalability in scalable video coding are provided by the disclosure. A distortion value of a base layer, a distortion value of an enhancement layer, a rate value of the base layer and a rate value the enhancement layer may be estimated according to different combinations of a block partition size of a base layer block, a transform block size of a base layer transform, a quantization parameter of a base layer quantization, a block partition size of an enhancement layer block, a transform block size of an enhancement layer transform, a quantization parameter of an enhancement layer quantization and a setting of the inter-prediction. Furthermore, the disclosure may further select a mode pair for the coarse grain scalability in scalable video coding according to the distortion value of the base layer, the distortion value of the enhancement layer, the rate value of base layer and the rate value of the enhancement layer. Therefore, the disclosure may increase the rate of mode decision during the coding process, so as to increase the coding speed and achieve rate control to effectively distribute the limited bandwidth.

It will be apparent to those skilled in the art that various modifications and variations can be made to the architecture of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A mode-dependent distortion estimation method for coarse grain scalability in scalable video coding, wherein the coarse grain scalability in scalable video coding performs a base layer coding and an enhancement layer coding on a macroblock, wherein when performing the base layer coding, the macroblock comprises a base layer block and performs a base layer transform as well as a base layer quantization so as to obtain a plurality of base layer transform coefficients of a plurality of base layer transform blocks, wherein when performing the enhancement layer coding, the macroblock comprises an enhancement layer block and performs an enhancement layer transform, an enhancement layer quantization as well as an inter-prediction so as to obtain a plurality of enhancement layer transform coefficients of a plurality of enhancement layer of transform blocks, wherein the distortion estimation method comprises:
respectively calculating a plurality of variances of the base layer transform coefficients for each of the base layer transform blocks according to a block partition size of the base layer block, a transform block size of the base layer transform and a quantization parameter of the base layer quantization;
obtaining a distribution of the base layer transform coefficients according to the variances of the base layer transform coefficients, and respectively calculating an expected value of a quantization error of the base layer transform coefficients for each of the base layer transform blocks according to the distribution of the base layer transform blocks and a quantization constant of the base layer quantization;
accumulating the expected value of the quantization error of the base layer transform coefficients of each of the base layer transform blocks so as to generate a distortion value of the base layer;
respectively calculating a plurality of variances of the enhancement layer transform coefficients for each of the enhancement layer transform blocks according to the block partition size of the base layer block, the transform block size of the base layer transform, the quantization parameter of the base layer quantization, a block partition size of the enhancement layer block, a transform block size of the enhancement layer transform, a quantization parameter of the enhancement layer quantization and a setting of the inter-prediction;
obtaining a distribution of the enhancement layer transform coefficients according to the variances of the enhancement layer transform coefficients, and respectively calculating an expected value of the quantization error of the enhancement layer transform coefficients for each of the enhancement layer transform blocks according to the distribution of the enhancement layer transform coefficients and a quantization constant of the enhancement layer quantization; and
accumulating the expected value of the quantization error of the enhancement layer transform coefficients of each of the enhancement layer transform blocks so as to generate a distortion value of the enhancement layer.

2. The distortion estimation method as claimed in claim 1, wherein the step of calculating the variances of the base layer transform coefficients for each of the base layer transform blocks comprises:
respectively calculating a variance of each of the base layer transform blocks in a spatial domain as well as a covariance between each of the base layer transform blocks and one of its adjacent blocks in the spatial domain; and
respectively calculating a variance of each of the base layer transform blocks in a transform domain as well as a covariance between each of the base layer transform blocks and one of its adjacent blocks in the transform domain so as to obtain the variances of the base layer transform coefficients.

3. The distortion estimation method as claimed in claim 1, wherein the step of calculating the variances of the enhancement layer transform coefficients for each of the enhancement layer transform blocks comprises:
respectively calculating a variance of each of the enhancement layer transform blocks in a spatial domain as well as a covariance between each of the enhancement layer transform blocks and one of its adjacent blocks in the spatial domain; and
respectively calculating a variance of each of the enhancement layer transform blocks in a transform domain and a covariance between each of the enhancement layer transform blocks and one of its adjacent blocks in the transform domain so as to obtain the variances of the enhancement layer transform coefficients by utilizing the quantization error of the enhancement layer transform coefficients.

4. The distortion estimation method as claimed in claim 1, wherein the steps of obtaining the distributions of the base layer transform coefficients and the enhancement layer transform coefficients comprise:
respectively substituting the variances of the base layer transform coefficients and the enhancement layer transform coefficients into a zero-mean Laplace distribution model.

5. A mode-dependent distortion estimation apparatus for coarse grain scalability in scalable video coding, wherein the coarse grain scalability in scalable video coding performs a base layer coding and an enhancement layer coding on a macroblock, wherein when performing the base layer coding, the macroblock comprises a base layer block and performs a base layer transform as well as a base layer quantization so as to obtain a plurality of base layer transform coefficients of a plurality of base layer transform blocks, wherein when performing the enhancement layer coding, the macroblock comprises an enhancement layer block and performs an enhancement layer transform, an enhancement layer quantization as well as an inter-prediction so as to obtain a plurality of enhancement layer transform coefficients of a plurality of enhancement layer of transform blocks, wherein the distortion estimation apparatus comprises:
a base layer variance calculator, configured to respectively calculate a plurality of variances of the base layer transform coefficients for each of the base layer transform blocks according to a block partition size of the base layer block, a transform block size of the base layer transform and a quantization parameter of the base layer quantization;
a base layer quantization error calculator, configured to obtain a distribution of the base layer transform coefficients according to the variances of the base layer transform coefficients, and to respectively calculate an expected value of a quantization error of the base layer transform coefficients for each of the base layer transform blocks according to the distribution of the base layer transform blocks and a quantization parameter of the base layer quantization;
a base layer distortion estimator, configured to accumulate the expected value of the quantization error of the base layer transform coefficients of each of the base layer transform blocks so as to generate a distortion of the base layer;
an enhancement layer variance calculator, configured to respectively calculate a plurality of variances of the enhancement layer transform coefficients for each of the enhancement layer transform blocks according to the block partition size of the base layer block, the transform block size of the base layer transform, the quantization parameter of the base layer quantization, a block partition size of the enhancement layer block, a transform block size of the enhancement layer transform, a quantization parameter of the enhancement layer quantization and a setting of the inter-prediction;
an enhancement layer quantization error calculator, configured to obtain a distribution of the enhancement layer transform coefficients according to the variances of the enhancement layer transform coefficients, and to respectively calculate an expected value of the quantization error of the enhancement layer transform coefficients for each of the enhancement layer transform blocks according to the distribution of the enhancement layer transform coefficients and a quantization constant of the enhancement layer quantization; and
an enhancement layer distortion estimator, configured to accumulate the expected value of the quantization error of the enhancement layer transform coefficients of each of the enhancement layer transform blocks so as to generate a distortion value of the enhancement layer.

6. The distortion estimation apparatus as claimed in claim 5, wherein the base layer variance calculator is configured to:
respectively calculate a variance of each of the base layer transform blocks in a spatial domain as well as a covariance between each of the base layer transform blocks and one of its adjacent blocks in the spatial domain, and
respectively calculate a variance of each of the base layer transform blocks in a transform domain as well as a covariance between each of the base layer transform blocks and one of its adjacent blocks in the transform domain so as to obtain the variances of the base layer transform coefficients.

7. The distortion estimation apparatus as claimed in claim 5, wherein the enhancement layer variance calculator is configured to:
respectively calculate a variance of each of the enhancement layer transform blocks in a spatial domain as well as a covariance between each of the enhancement layer transform blocks and one of its adjacent blocks in the spatial domain, and
respectively calculate a variance of each of the enhancement layer transform blocks in a transform domain as well as a covariance between each of the enhancement layer transform blocks and one of its adjacent blocks in the transform domain so as to obtain the variances of the enhancement layer transform coefficients by utilizing the quantization error of the enhancement layer transform coefficients.

8. The distortion estimation apparatus as claimed in claim 5, wherein the base layer quantization error calculator and the enhancement layer quantization error calculator are configured to:
respectively substitute the variances of the base layer transform coefficients and the enhancement layer transform coefficients into a zero-mean Laplace distribution model.

9. A method of selecting a mode pair for coarse grain scalability in scalable video coding, wherein the coarse grain scalability in scalable video coding performs a base layer coding and an enhancement layer coding on a macroblock, wherein when performing the base layer coding, the macroblock comprises a base layer block and performs a base layer transform as well as a base layer quantization so as to obtain a plurality of base layer transform coefficients of a plurality of base layer transform blocks, wherein when performing the enhancement layer coding, the macroblock comprises an enhancement layer block and performs an enhancement layer transform, an enhancement layer quantization as well as an inter-prediction so as to obtain a plurality of enhancement layer transform coefficients of a plurality of enhancement layer of transform blocks, wherein the method comprises:
estimating a distortion value of the base layer and a distortion value of the enhancement layer of a plurality of different combinations according to the different combinations of a block partition size of the base layer block, a transform block size of the base layer transform, a quantization parameter of the base layer quantization, a block partition size of the enhancement layer block, a transform block size of the enhancement layer transform, a quantization parameter of the enhancement layer quantization and a setting of the inter-prediction; and
selecting the mode pair for the coarse grain scalability in scalable video coding according to the distortion value of the base layer and the distortion value of the enhancement layer.

10. The method as claimed in claim 9, wherein the step of estimating the distortion value of the base layer and the distortion value of the enhancement layer comprises:
respectively calculating a plurality of variances of the base layer transform coefficients for each of the base layer transform blocks according to a block partition size of the base layer block, a transform block size of the base layer transform and a quantization parameter of the base layer quantization;
obtaining a distribution of the base layer transform coefficients according to the variances of the base layer transform coefficients, and respectively calculating an expected value of a quantization error of the base layer transform coefficients for each of the base layer transform blocks according to the distribution of the base layer transform blocks and a quantization constant of the base layer quantization;
accumulating the expected value of the quantization error of the base layer transform coefficients of each of the base layer transform blocks so as to generate the distortion value of the base layer;
respectively calculating a plurality of variances of the enhancement layer transform coefficients for each of the enhancement layer transform blocks according to the block partition size of the base layer block, the transform block size of the base layer transform, the quantization parameter of the base layer quantization, a block partition size of the enhancement layer block, a transform block size of the enhancement layer transform, a quantization parameter of the enhancement layer quantization and a setting of the inter-prediction;
obtaining a distribution of the enhancement layer transform coefficients according to the variances of the enhancement layer transform coefficients, and respectively calculating an expected value of the quantization error of the enhancement layer transform coefficients for each of the enhancement layer transform blocks according to the distribution of the enhancement layer transform coefficients and a quantization constant of the enhancement layer quantization; and
accumulating the expected value of the quantization error of the enhancement layer transform coefficients of the enhancement layer transform blocks so as to generate the distortion value of the enhancement layer.

11. A mode-dependent rate estimation method for coarse grain scalability in a scalable video coding, wherein the coarse grain scalability in scalable video coding performs a base layer coding and an enhancement layer coding on a macroblock, wherein when performing the base layer coding, the macroblock comprises a base layer block and performs a base layer transform as well as a base layer quantization so as to obtain a plurality of base layer transform coefficients of a plurality of base layer transform blocks, wherein when performing the enhancement layer coding, the macroblock comprises an enhancement layer block and performs an enhancement layer transform, an enhancement layer quantization as well as an inter-prediction so as to obtain a plurality of enhancement layer transform coefficients of a plurality of enhancement layer of transform blocks, wherein the rate estimation method comprises:
respectively calculating a plurality of variances of the base layer transform coefficients for each of the base layer transform blocks according to a block partition size of the base layer block, a transform block size of the base layer transform and a quantization parameter of the base layer quantization;
obtaining a distribution of the base layer transform coefficients according to the variances of the base layer transform coefficients, and respectively calculating an entropy of the base layer transform coefficients for each of the base layer transform blocks according to the distribution of the base layer transform blocks and a quantization constant of the base layer quantization;
processing of the entropy of the base layer transform coefficients of each of the base layer transform blocks so as to generate a rate value of the base layer;
respectively calculating a plurality of variances of the enhancement layer transform coefficients for each of the enhancement layer transform blocks according to the block partition size of the base layer block, the transform block size of the base layer transform, the quantization parameter of the base layer quantization, a block partition size of the enhancement layer block, a transform block size of the enhancement layer transform, a quantization parameter of the enhancement layer quantization and a setting of the inter-prediction;
obtaining a distribution of the enhancement layer transform coefficients according to the variances of the enhancement layer transform coefficients, and respectively calculating an entropy of the enhancement layer transform coefficients for each of the enhancement layer transform blocks according to the distribution of the enhancement layer transform coefficients and a quantization constant of the enhancement layer quantization; and
processing the entropy of the enhancement layer transform coefficients of each of the enhancement layer transform blocks so as to generate a rate value of the enhancement layer.

12. The rate estimation method as claimed in claim 11, wherein the step of calculating the variances of the base layer transform coefficients for each of the base layer transform blocks comprises:
respectively calculating a variance of each of the base layer transform blocks in a spatial domain as well as a covariance between each of the base layer transform blocks and one of its adjacent blocks in the spatial domain; and
respectively calculating a variance of each of the base layer transform blocks in a transform domain as well as a covariance between each of the base layer transform blocks and one of its adjacent blocks in the transform domain so as to obtain the variances of the base layer transform coefficients.

13. The rate estimation method as claimed in claim 11, wherein the step of calculating the variances of the enhancement layer transform coefficients comprises:
respectively calculating a variance of each of the enhancement layer transform blocks in a spatial domain as well as a covariance between each of the enhancement layer transform blocks and one of its adjacent blocks in the spatial domain; and
respectively calculating a variance of each of the enhancement layer transform blocks in a transform domain as well as a covariance between each of the enhancement layer transform blocks and one of its adjacent blocks in the transform domain, so as to obtain the variances of the enhancement layer transform coefficients by utilizing a quantization error of the enhancement layer transform coefficient.

14. The rate estimation method as claimed in claim 11, wherein the steps of obtaining the distribution of the base layer transform coefficients and the distribution of the enhancement layer transform coefficients comprise:
respectively substituting the variances of the base layer transform coefficients and the enhancement layer transform coefficients into a zero-mean Laplace distribution model.

15. A mode-dependent rate estimation apparatus for coarse grain scalability in scalable video coding, wherein the coarse grain scalability in scalable video coding performs a base layer coding and an enhancement layer coding on a macroblock, wherein when performing the base layer coding, the macroblock comprises a base layer block and performs a base layer transform as well as a base layer quantization so as to obtain a plurality of base layer transform coefficients of a plurality of base layer transform blocks, wherein when performing the enhancement layer coding, the macroblock comprises an enhancement layer block and performs an enhancement layer transform, an enhancement layer quantization as well as an inter-prediction so as to obtain a plurality of enhancement layer transform coefficients of a plurality of enhancement layer of transform blocks, wherein the rate estimation apparatus comprises:
a base layer variance calculator, configured to respectively calculate a plurality of variances of the base layer transform coefficients for each of the base layer transform blocks according to a block partition size of the base layer block, a transform block size of the base layer transform and a quantization parameter of the base layer quantization;
a base layer entropy calculator, configured to obtain a distribution of the base layer transform coefficients according to the variances of the base layer transform coefficients, and to respectively calculate an entropy of the base layer transform coefficients for each of the base layer transform blocks according to the distribution of the base layer transform coefficients and a quantization constant of the base layer quantization;
a base layer rate estimator, configured to process the entropy of the base layer transform coefficients of each of the base layer transform blocks so as to generate a rate value of the base layer;
an enhancement layer variance calculator, configured to respectively calculate a plurality of variances of the enhancement layer transform coefficients for each of the enhancement layer transform blocks according to the block partition size of the base layer block, the transform block size of the base layer transform, the quantization parameter of the base layer quantization, a block partition size of the enhancement layer block, a transform block size of the enhancement layer transform, a quantization parameter of the enhancement layer quantization and a setting of the inter-prediction;
an enhancement layer entropy calculator, configured to obtain a distribution of the enhancement layer transform coefficients according to the variances of the enhancement layer transform coefficients, and to respectively calculate an entropy of the enhancement layer transform coefficients for each of the enhancement layer transform blocks according to the distribution of the enhancement layer transform coefficients and a quantization constant of the enhancement layer quantization; and
an enhancement layer rate estimator, configured to process the entropy of the enhancement layer transform coefficients of each of the enhancement layer transform blocks so as to generate a rate value of the enhancement layer.

16. The rate estimation apparatus as claimed in claim 15, wherein the base layer variance calculator is configured to:
respectively calculate a variance of each of the base layer transform blocks in a spatial domain as well as a covariance between each of the base layer transform blocks and one of its adjacent blocks in the spatial domain, and
respectively calculate a variance of each of the base layer transform blocks in a transform domain as well as a covariance between each of the base layer transform blocks and one of its adjacent blocks in the transform domain, so as to obtain the variances of the base layer transform coefficients.

17. The rate estimation apparatus as claimed in claim 15, wherein the enhancement layer variance calculator is configured to:
respectively calculate a variance of each of the enhancement layer transform blocks in a spatial domain as well as a covariance between each of the enhancement layer transform blocks and one of its adjacent blocks in the spatial domain, and
respectively calculate a variance of each of the enhancement layer transform blocks in a transform domain as well as a covariance between each of the enhancement layer transform blocks and one of its adjacent blocks in the transform domain, so as to obtain the variances of the enhancement layer transform coefficients by utilizing a quantization error of the enhancement layer transform coefficients.

18. The rate estimation apparatus as claimed in claim 15, wherein the base layer entropy calculator and the enhancement layer entropy calculator are configured to:
respectively substitute the variances of the base layer transform coefficients and the enhancement layer transform coefficients into a zero-mean Laplace distribution model so as to obtain the distribution of the base layer transform coefficients and the distribution of the enhancement layer transform coefficients.

19. A method of selecting a mode pair for coarse grain scalability in scalable video coding, wherein the coarse grain scalability in scalable video coding performs a base layer coding and an enhancement layer coding on a macroblock, wherein when performing the base layer coding, the macroblock comprises a base layer block and performs a base layer transform as well as a base layer quantization, so as to obtain a plurality of base layer transform coefficients of a plurality of base layer transform blocks, wherein when performing the enhancement layer coding, the macroblock comprises an enhancement layer block and performs an enhancement layer transform, an enhancement layer quantization as well as an inter-prediction so as to obtain a plurality of enhancement layer transform coefficients of a plurality of enhancement layer of transform blocks, wherein the method comprises:
estimating a rate value of the base layer and a rate value of the enhancement layer of a plurality of different combinations according to the different combinations of a block partition size of the base layer block, a transform block sizes of the base layer transform, a quantization parameter of the base layer quantization, a block partition size of the enhancement layer block, a transform block size of the enhancement layer transform, a quantization parameter of the enhancement layer quantization and a setting of the inter-prediction; and
selecting the mode pair of the coarse grain scalability in scalable video coding according to the rate value of the base layer and the rate value of the enhancement layer.

20. The method as claimed in claim 19, wherein the steps of estimating the rate value of the base layer and the rate value of the enhancement layer comprises:
respectively calculating a plurality of variances of the base layer transform coefficients for each of the base layer transform blocks according to a block partition size of the base layer block, a transform block size of the base layer transform and a quantization parameter of the base layer quantization;
obtaining a distribution of the base layer transform coefficients according to the variances of the base layer transform coefficients, and respectively calculating an entropy of the base layer transform coefficients for each of the base layer transform blocks according to the distribution of the base layer transform blocks and a quantization constant of the base layer quantization;
processing the entropy of the base layer transform coefficients of each of the base layer transform blocks so as to generate a rate value of the base layer
respectively calculating a plurality of variances of the enhancement layer transform coefficients for each of the enhancement layer transform blocks according to the block partition size of the base layer block, the transform block size of the base layer transform, the quantization parameter of the base layer quantization, a block partition size of the enhancement layer block, a transform block size of the enhancement layer transform, a quantization parameter of the enhancement layer quantization and a setting of the inter-prediction;
obtaining a distribution of the enhancement layer transform coefficients according to the variances of the enhancement layer transform coefficients, and respectively calculating an entropy of the enhancement layer transform coefficients for each of the enhancement layer transform blocks according to the distribution of the enhancement layer transform coefficients and a quantization constant of the enhancement layer quantization; and
processing the entropy of the enhancement layer transform coefficients of the enhancement layer transform blocks so as to generate a rate value of the enhancement layer.
